(19) United States
(12) Patent Application Publication
(10) Pub. No.: US 2022/0108829 A1
(43) Pub. Date: Apr. 7, 2022

(54) WIRE FOR USE IN TRANSFORMER WINDING AND TRANSFORMER

(71) Applicants: EAGLERISE INTELLIGENT DEVICE CORPORATION LTD., Foshan, Guangdong (CN); FOSHAN EAGLERISE POWER SCIENCE & TECHNOLOGY (SHUNDE) CO., LTD., Foshan, Guangdong (CN)

(72) Inventors: Kakuryo Sho, Foshan, Guangdong (CN); Juncheng Xiao, Foshan, Guangdong (CN); Yilong Wang, Foshan, Guangdong (CN)

(21) Appl. No.: 17/427,913

(22) PCT Filed: Feb. 15, 2019
(86) PCT No.: PCT/CN2019/075149

§ 371 Date: Aug. 2, 2021

(51) Int. Cl. H01F 27/28; H01F 27/24; H01F 27/32

(52) U.S. Cl. CPC H01F 27/2823; H01F 27/327; H01F 27/2885; H01F 27/24

(57) ABSTRACT

Disclosed are a conducting wire for transformer windings and a transformer. The conducting wire includes a first insulating layer in which two wire cores are arranged, wherein each wire core is sequentially wrapped with a second insulating layer and a metal shielding layer. Coils of a primary winding and a secondary winding of the transformer are formed by winding the conducting wire in a double-wire parallel winding manner. A power supply using the transformer has good symmetry, and the DC resistance and AC impedance of the primary winding and the secondary winding are symmetrical, and the parameters of the primary winding and the secondary winding are same, therefore, it is beneficial to suppressing the common mode interference, and the magnetic saturation can be prevented to a certain extent, so it is also beneficial to the electromagnetic compatibility of the transformer.

### TECHNICAL FIELD

The present invention relates to the field of transformers, in particular to a conducting wire for transformer windings, and a transformer.

### BACKGROUND ART

A high-frequency transformer is a power supply transformer with working frequency exceeding 10 KHz, is mainly used as a high-frequency transformation switching power supply transformer, and is also used as a high-frequency inverter transformer in a high-frequency inverter and a high-frequency inverter welding machine. Along with the development of the battery technology and the high-power power electronic technology, for example, traction power transformation devices for large-scale charging stations and high-speed rails, high-power direct current transformation isolation power transmission equipment such as direct current power transmission and grid-connected photovoltaic power generation equipment, in order to improve the conversion efficiency of electric energy, reduce the volume and reduce the cost, it needs to develop a high-frequency high-power transformer which can isolate tens of thousands of volts and prevent partial discharge caused by high frequency and high voltage. Especially for a power supply transformer of a high-frequency transformation switch, since a high-frequency switching device has an extremely high dV/dt voltage change ratio while working, in order to prevent the partial discharge of a high-power high-frequency transformer under a small high voltage resistant condition, the traditional method is to separately wind a primary winding and a secondary winding of the transformer as much as possible, and perform vacuum pouring encapsulation by using high voltage resistant and insulating epoxy resin, silica gel, polyurethane and other materials, so that gapless insulating encapsulation with a distance exceeding tens of millimeters is formed between the primary winding and the secondary winding. According to the high-frequency transformer adopting this technology, firstly, since the distance between the primary winding and the secondary winding is large, the volume of the transformer is large; secondly, since the primary winding and the secondary winding are respectively wound, the windings of the transformer have a quite serious high frequency proximity effect, so that the high frequency loss of the coil windings of the transformer is increased, and the efficiency is reduced; and thirdly, since the primary winding and the secondary winding of the transformer are wound separately, the winding balance degree cannot be guaranteed, and the leakage inductance of the transformer is relatively large.

### SUMMARY OF INVENTION

The present invention mainly provides a conducting wire for transformer windings, and a transformer, so as to solve the technical problems of a large volume, a serious proximity effect and relatively large leakage inductance of a high-frequency transformer caused by the overlarge distance between a primary winding and a secondary winding due to the fact that the primary winding and the secondary winding of the high-frequency transformer are respectively wound.

According to a first aspect, a conducting wire for transformer windings is provided in one embodiment, including a first insulating layer in which two wire cores are arranged, wherein each wire core is sequentially wrapped with a second insulating layer and a metal shielding layer.

According to a second aspect, a transformer is provided in one embodiment, including the conducting wire in the first aspect, wherein one wire core of the conducting wire serves as a primary winding of the transformer, and the other wire core serves as a secondary winding of the transformer.

According to the conducting wire for transformer windings and the transformer in the above embodiments, each wire core of the conducting wire is sequentially wrapped with the insulating layer and the metal shielding layer, one wire core serves as the conducting wire of the coil of the primary winding, and the other wire core serves as the conducting wire of the coil of the secondary winding. Since the primary winding and the secondary winding are wound in a double-wire parallel winding method, the direct current resistances of the two windings of the transformer are symmetrical, so that the symmetry of the power supply is good.

### BRIEF DESCRIPTION OF DRAWINGS

FIG. 1 is a schematic diagram of a partial section structure of a transformer in which a coil is wound in a layer-by-layer winding method;

FIG. 2 is a schematic diagram of a section structure of a transformer in which a coil is wound in a double-wire parallel winding method;

FIG. 3 is a schematic structural diagram of a conducting wire for transformer windings in one embodiment;

FIG. 4 is a schematic section diagram of the conducting wire for transformer windings in one embodiment;

FIG. 5 is a schematic structural diagram of a conducting wire for transformer windings in another embodiment;

FIG. 6 is a schematic structural diagram of a conducting wire for transformer windings in another embodiment;

FIG. 7 is a schematic structural diagram of a transformer in another embodiment;

FIG. 8 is a schematic diagram of a partial section of a transformer in another embodiment; and

FIG. 9 is a schematic circuit diagram of a transformer in another embodiment.

### DETAIL DESCRIPTION

Hereinafter, the present invention will be further described in detail through specific embodiments in conjunction with the drawings. Similar elements in different embodiments adopt associated similar element numbers. In the following embodiments, many detailed descriptions are adopted for better understanding of the present application. However, those skilled in the art can recognize without effort that part of the features can be omitted under different circumstances, or can be replaced by other elements, materials and methods. In some cases, some operations related to the present application are not shown or described in the specification, in order to avoid the core part of the present application from being overwhelmed by excessive descriptions. It is not necessary for those skilled in the art to describe these related operations in detail, and they can fully understand the related operations from the description in the specification and the general technical knowledge in the art.

In addition, the characteristics, operations or features described in the specification can be combined in any appropriate manner to form various embodiments. At the same time, the steps or actions in the method description can also be sequentially exchanged or adjusted in a manner that is obvious to those skilled in the art. Therefore, the various sequences in the specification and the drawings are only for the purpose of clearly describing some embodiment, and are not meant to be necessary sequences, unless it is otherwise specified that a certain sequence must be followed.

The serial numbers themselves, for example, “first”, “second” and the like, of components herein are only used for distinguishing the described objects and do not have any sequence or technical meaning. The words “connection” and “link” mentioned in the present application include direct and indirect connections (links) unless otherwise specified.

When a high-frequency transformer is designed, the leakage inductance and distributed capacitance of the transformer must be minimized, especially high-frequency pulse square wave signals transmitted by the high-frequency transformer in a switching power supply. During the transient process of transmission, the leakage inductance and the distributed capacitance will cause surge current and a peak voltage, as well as top oscillation, resulting in increased loss. Therefore, it is necessary to find a way to tightly couple the coils of a primary winding and a secondary winding together, so that the leakage inductance of the transformer can be reduced. Since the leakage inductance is too large, it will cause a larger spike pulse, which will break through a switching tube. Therefore, when the coils of the high-frequency transformer are wound, the distance between the coils of the primary winding and the secondary winding should be as close as possible. Generally, the coils of the primary winding and the secondary winding are wound by a double-wire parallel winding method, a layer-by-layer winding method, a sandwich winding method, and so on.

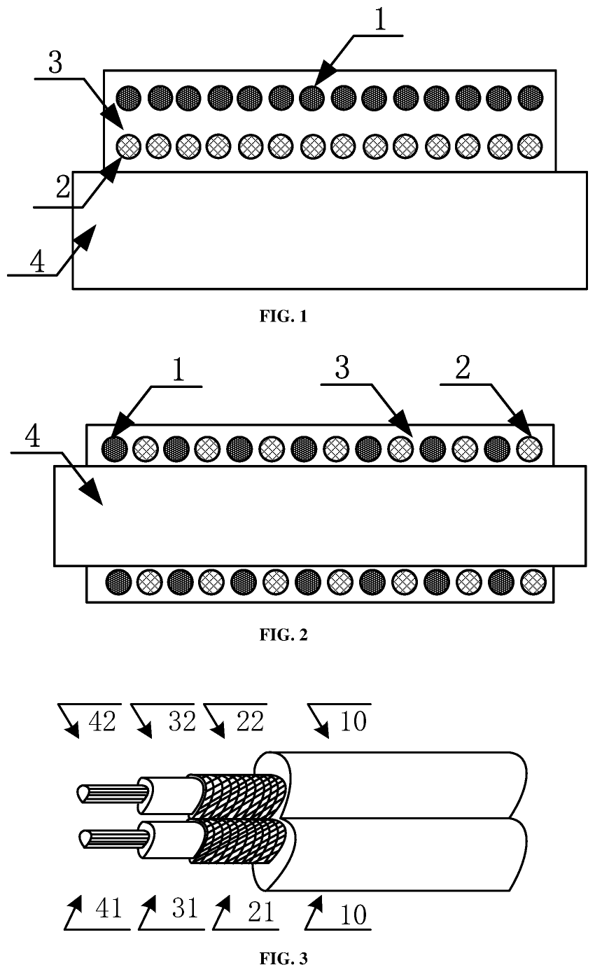

As shown in FIG. 1, it is a schematic diagram of a partial section structure of a transformer in which a coil is wound in a layer-by-layer winding method, including a magnetic core 4, a primary winding 2, a secondary winding 1 and an insulating material 3. In the layer-by-layer winding method, the primary winding 2 and the secondary winding 1 are wound around the magnetic core 4 in layers, the primary winding can also be wound in odd layers 1, 3 and 5, and the secondary winding is wound in even layers 2, 4 and 6. In the sandwich winding method, the secondary winding is wound in the middle of the primary winding, and the primary winding is wound for several times.

As shown in FIG. 2, it is a schematic diagram of a section structure of a transformer in which a coil is wound in a double-wire parallel winding method, including a magnetic core 4, a primary winding 2, a secondary winding 1 and an insulating material 3. The conducting wires of the primary winding 2 and the secondary winding 1 are combined and wound around the magnetic core 4. In the double-wire parallel winding method, the distance between the coils of the primary winding 2 and the secondary winding 1 is the minimum, so that the leakage inductance can be reduced to a minimum value. However, the withstand voltage between two wires is relatively low in this winding method in the prior art. The main reason is that there are materials with different dielectric constants and different insulation strengths between the coils of the primary winding 2 and the secondary winding 1 of the transformer, such as insulating materials, air, sundries and pouring sealants. These substances have different spacing sizes and conductivity, when high frequency and high voltage are applied between the coils of the primary winding 2 and the secondary winding 1 of the transformer, although high voltage breakdown may not occur between the coils of the primary winding 2 and the secondary winding 1, the distributed voltages on different substances have very large deviations, and a continuous high voltage discharge phenomenon will occur on some insulating substances, resulting in the deterioration of the corresponding insulating materials, and insulation damage will occur in severe cases.

In the embodiment of the present invention, a conducting wire for transformer windings includes a first insulating layer in which two wire cores are arranged, wherein each wire core is sequentially wrapped with a second insulating layer and a metal shielding layer. The conducting wire is wound around the primary winding and the secondary winding of the transformer in a double-wire parallel winding manner.

### Embodiment 1

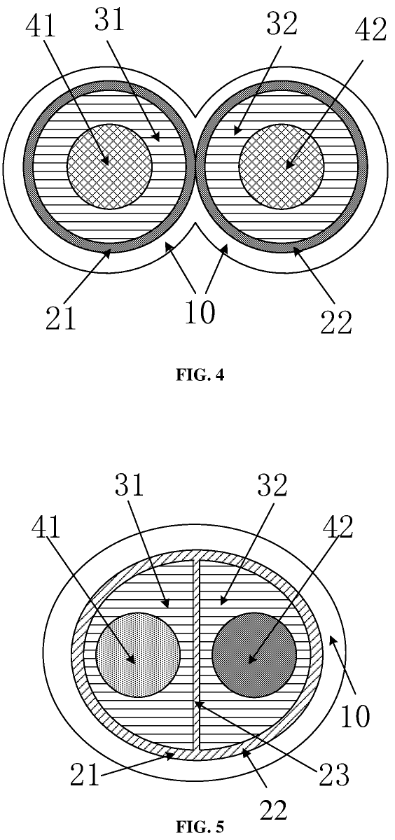

As shown in FIG. 3 and FIG. 4, they are a schematic structural diagram of a conducting wire for transformer windings and a schematic section diagram of the conducting wire in one embodiment. The conducting wire includes a first insulating layer 10, a first wire core 41 and a second wire core 42. The first wire core 41 is sequentially wrapped with a second insulating layer 31 and a metal shielding layer 21. The second wire core 42 is sequentially wrapped with a second insulating layer 32 and a metal shielding layer 22. The metal shielding layer 21 and the metal shielding layer 22 of the first wire core 41 and the second wire core 42 are electrically connected. The materials of the first wire core 41 and the second wire core 42 can be the same or different. The second insulating layer 31 and the second insulating layer 32 have the same thickness and the same material. In one embodiment, the first wire core 41 and the second wire core 42 are single-core or multi-core stranded wire cores. In one embodiment, the first wire core 41 and the second wire core 42 are at least one of a round conducting wire, a square conducting wire, or a flat conducting wire. In one embodiment, the metal shielding layer 21 and the metal shielding layer 22 are electrically connected in a contact manner, that is, any segments of the metal shielding layer 21 and the metal shielding layer 22 are in close contact on the conducting wire, and are electrically connected. In one embodiment, the metal shielding layer 21 and the metal shielding layer 22 are metal films or metal wire woven meshes. In one embodiment, the metal shielding layer 21 and the metal shielding layer 22 are metal coils formed by spirally winding a single or multiple thin conducting wires. In one embodiment, the material of the metal shielding layer 21 and the metal shielding layer 22 is copper or aluminum. In one embodiment, the metal shielding layer 21 and the metal shielding layer 22 are arranged in the first insulating layer 10 in contact with each other. Further, in the transformer on which the conducting wire is wound in the embodiment of the present application, the metal shielding layer 21 and the metal shielding layer 22 are used for grounding.

As shown in FIG. 5, it is a schematic structural diagram of a conducting wire for transformer windings in another embodiment. The conducting wire includes a first insulating layer 10, a first wire core 41 and a second wire core 42. The first wire core 41 is sequentially wrapped with a second insulating layer 31 and a metal shielding layer 21. The second wire core 42 is sequentially wrapped with a second insulating layer 32 and a metal shielding layer 22. The metal shielding layer 21 and the metal shielding layer 22 share a same segment 23 on periphery of each other.

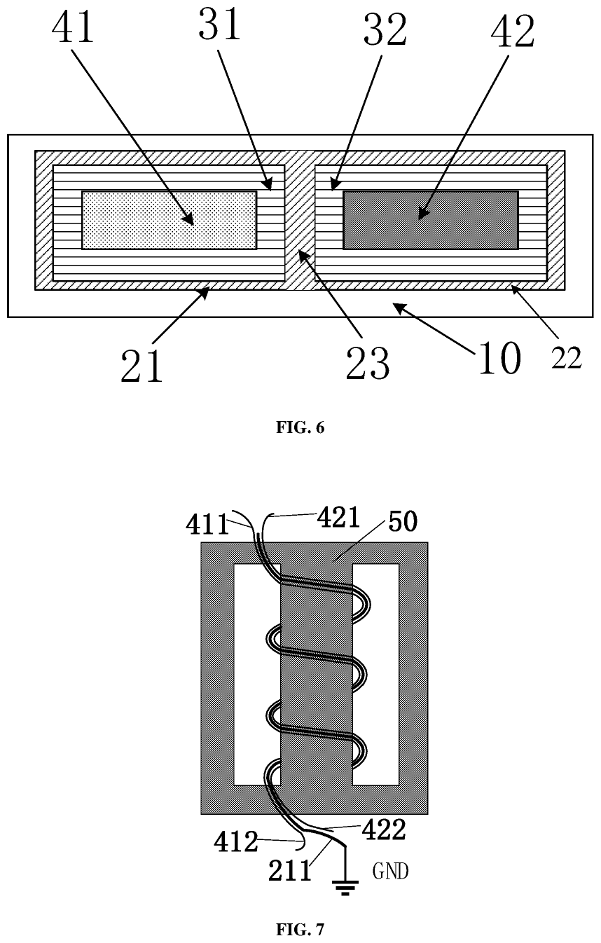

As shown in FIG. 6, it is a schematic structural diagram of a conducting wire for transformer windings in another embodiment. The conducting wire includes a first insulating layer 10, a first wire core 41 and a second wire core 42. The first wire core 41 is sequentially wrapped with a second insulating layer 31 and a metal shielding layer 21. The second wire core 42 is sequentially wrapped with a second insulating layer 32 and a metal shielding layer 22. The metal shielding layer 21 and the metal shielding layer 22 share a same segment 23 on periphery of each other. The first wire core 41 and the second wire core 42 are square conducting wires.

In one embodiment, the metal shielding layer 21 and the metal shielding layer 22 are of grid structures, that is, they are metal shielding meshes, and grid structures that occupy small surface spaces are preferably used. Or, the metal shielding layer 21 and the metal shielding layer 22 are strip-shaped metal foils. The plane occupancy rate of the shielding mesh or the strip-shaped metal foil is not greater than 50%, and preferably not greater than 5%. Specifically, the shielding mesh or the strip-shaped metal foil can be sparsely braided by fine metal wires, and the diameter of a hole thereof is preferably greater than 1 mm. The metal is preferably copper and aluminum.

In the embodiment disclosed by the present application, the conducting wire for transformer windings adopts a novel insulating structure, so that the first wire core 41 and the second wire core 42 are completely covered by the same insulating material, and the metal shielding layer 21 and the metal shielding layer 22 of the first wire core 41 and the second wire core 42 are in close contact and are electrically connected. With respect to the entire conductor, the insulating material between the first wire core 41 and the second wire core 42 is evenly separated by the contact position of the metal shielding layer 21 and the metal shielding layer 22, that is, a voltage resistance layer formed by the insulating structure between the first wire core 41 and the second wire core 42 is evenly divided into two voltage resistance layers. Therefore, the conducting wires of the coils of the primary winding and the secondary winding are isolated by two independent insulating layers of the same insulating material, the insulating layer is separated from the middle by the shielding layer made of a conductive material and is grounded, the conducting wires of the coils of the primary winding and the secondary winding are arranged in parallel, and the outer sides of the conducting wires are wrapped in an insulating manner. In the transformer adopting the conducting wire for transformer windings disclosed in the embodiment of the present application, except for the two layers of insulating materials of the same material and same thickness between the coils of the primary winding and the secondary winding, there are no other insulating materials of different dielectrics, even if insulation treatment is carried out on the entire transformer by using various encapsulation processes, all insulating encapsulation materials will not fill and enter the space between the conducting wires of the coils of the primary winding and the secondary winding, and other insulating encapsulation materials will not withstand any electric field voltage, therefore, the phenomenon of high-voltage partial discharge between the coils of the primary winding and the secondary winding of the traditional transformer is completely eliminated. In this way, no continuous high-voltage discharge phenomenon is generated between different insulating substances, thereby preventing the deterioration of the insulating material.

### Embodiment 2

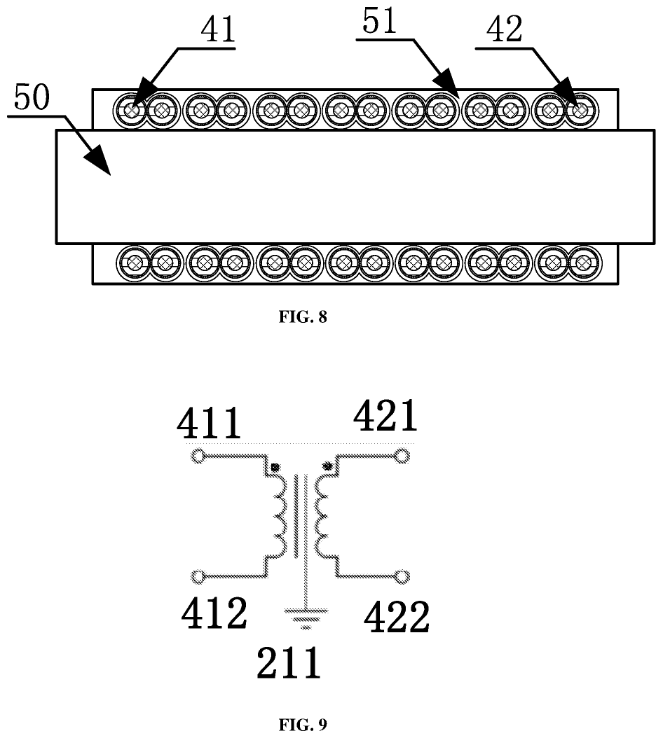

As shown in FIG. 7 and FIG. 8, they are a schematic structural diagram and a schematic diagram of a partial section of a transformer in another embodiment. The transformer includes the conducting wire disclosed by the present application and a magnetic core 50. The magnetic core 50 is an E type magnetic core. The conducting wire is wound around the center pillar of the magnetic core 50. The conducting wire is wound around the primary winding and the secondary winding of the transformer in the double-wire parallel winding manner. The conducting wire includes a first wire core 41, a second wire core 42 and a metal shielding layer. The first wire core 41 includes a first end 411 and a second end 412, the second wire core 42 includes a third end 421 and a fourth end 422, and the metal shielding layer includes a grounding end point 211. The first end 411 and the second end 412 are used as an input end and an output end of the coil of the primary winding of the transformer, the third end 421 and the fourth end 422 are used as the input end and the output end of the coil of the secondary winding of the transformer, and the grounding end point 211 is used for grounding.

As shown in FIG. 9, it is a schematic circuit diagram of a transformer in another embodiment, including a first end 411, a second end 412, a third end 421, a fourth end 422 and a grounding end point 211. The first end 411 and the second end 412 are used as the input end and the output end of the coil of the primary winding of the transformer, the third end 421 and the fourth end 422 are used as the input end and the output end of the coil of the secondary winding of the transformer, and the grounding end point 211 is used for grounding.

In one embodiment, the magnetic core 50 is at least one of a soft magnetic ferrite magnetic core, an amorphous ribbon magnetic core, a nano amorphous ribbon magnetic core, or a soft magnetic core. In one embodiment, the magnetic core 50 can be other types of magnetic cores, and conducting wires are wound around the magnetic cores of various closed magnetic circuits to form the primary winding and the secondary winding of the transformer. In one embodiment, an insulating and sealing structure can be further added to the transformer disclosed by the present application, and the insulating and sealing structure is used for insulating and sealing the primary winding and the secondary winding. The material of the insulating and sealing structure can be sealed and encapsulated with insulating materials such as epoxy resin, silica gel and polyurethane for use, or no encapsulation is needed, and the primary winding and the secondary winding can also be used in a bare leakage state.

In one embodiment, the transformer disclosed by the present application is a high-frequency transformer, which is formed by adopting a transformation ratio of 1:1 of the primary winding and the secondary winding, that is, the ratio of the turns per coil of the primary winding to that of the secondary winding is 1:1. In order to achieve different transformation ratios, the transformer disclosed by the present application can use multiple conducting wires disclosed by the present application for winding for different numbers of turns, and then different numbers of turns of the primary winding and the secondary winding are in series-parallel combination at a lead wire to meet the requirements of different transformation ratios of the transformer.

The conducting wire disclosed by the present application is wound around the primary winding and the secondary winding of the transformer in the double-wire parallel winding manner. The power supply using the transformer has good symmetry, and the DC resistance and AC impedance of the primary winding and the secondary winding are symmetrical, and the winding operation is convenient. The parameters of the primary winding and the secondary winding are constant, it is beneficial to suppressing the common mode interference, and the magnetic saturation can be prevented to a certain extent, so it is also beneficial to the electromagnetic compatibility of the transformer. In this way, it is easy for the transformer to achieve high frequency and high power, the phenomenon of high frequency and high voltage partial discharge is greatly improved, and the transformer achieves ultra-low leakage inductance due to the primary and secondary coupling close to 100%.

Description is made herein with reference to various exemplary embodiments. However, those skilled in the art will recognize that changes and modifications can be made to the exemplary embodiments without departing from the scope of the text. For example, various operation steps and assemblies used for executing the operation steps can be implemented in different ways according to specific applications or by considering any number of cost functions associated with the operations of the system (for example, one or more steps can be deleted, modified or incorporated into other steps).

Although the principles of the text have been shown in various embodiments, many modifications of structures, arrangements, proportions, elements, materials and components that are particularly suitable for specific environments and operating requirements can be made without departing from the principles and scope of the this disclosure. The above modifications and other changes or amendments will be included in the scope of the text.

The foregoing detailed descriptions have been described with reference to various embodiments. However, those skilled in the art will recognize that various modifications and changes can be made without departing from the scope of the present disclosure. Therefore, the consideration of the present disclosure will be in an illustrative rather than restrictive sense, and all these modifications will be included in its scope. Likewise, the advantages, other advantages and solutions to problems of the various embodiments have been described above. However, benefits, advantages, solutions to problems, and any elements that can produce these, or solutions that make them more specific should not be construed as critical, essential or necessary. The term “including” and any other variants thereof used herein are non-exclusive inclusions. Such a process, method, article or equipment that includes a list of elements not only includes these elements, but also includes other elements that are not explicitly listed or do not belong to the process, method, system, article or device. In addition, the term “couple” and any other variants thereof used herein refer to physical connection, electrical connection, magnetic connection, optical connection, communication connection, functional connection and/or any other connection.

Those skilled in the art will recognize that many changes can be made to the details of the above-mentioned embodiments without departing from the basic principles of the present invention. Therefore, the scope of the present invention should be determined according to the following claims.

1. A conducting wire for transformer windings, comprising a first insulating layer and two wire cores, each wire core is sequentially wrapped with a second insulating layer and a metal shielding layer,
wherein
the metal shielding layers of the two wire cores are arranged in electrically contact with each other,
materials of the two wire cores are same,
thicknesses and materials of the second insulating layers of the two wire cores are same, and
the first insulating layer wraps the metal shielding layers of the two wire cores to keep the two wire cores symmetrical.

2. (canceled)

3. (canceled)

4. (canceled)

5. The conducting wire of claim 1, wherein the metal shielding layers of the two wire cores are in contact with each other, or electrically connected by further wires.

6. The conducting wire according to claim 1, wherein the metal shielding layers are used for grounding.

7. (canceled)

8. The conducting wire of claim 1, wherein the metal shielding layers of the two wire cores share a same segment on periphery of each other.

9. The conducting wire of claim 1, wherein each wire core is a single core; or, each wire core is a multi-core stranded wire core.

10. (canceled)

11. The conducting wire of claim 1, wherein the metal shielding layers are metal films or metal wire woven mesh.

12. The conducting wire of claim 11, wherein material of the metal shielding layers is copper or aluminum.

13. A transformer, comprising a magnetic core and a conducting wire according to claim 1, wherein the conducting wire which comprises two wire cores is wound in a double-wire parallel winding manner, one wire core in the conducting wire serves as a primary winding of the transformer, and another wire core serves as a secondary winding of the transformer.

14. (canceled)

15. (canceled)

16. The transformer of claim 13, wherein the metal shielding layers of the two wire cores are used for grounding.

17. The transformer of claim 13, wherein the transformer is a high-frequency transformer.

18. The transformer of claim 13, wherein ratio of turns per coil of the primary winding to that of the secondary winding is 1:1.

19. (canceled)

20. The transformer of claim 13, further comprising an insulating and sealing structure for insulating and sealing the primary winding and the secondary winding; wherein material used for insulating and sealing is at least one of epoxy resin, silica gel or polyurethane.
